(19) United States
(12) Patent Application Publication
(10) Pub. No.: US 2020/0105244 A1
(43) Pub. Date: Apr. 2, 2020

(54) SINGING VOICE SYNTHESIS METHOD AND SINGING VOICE SYNTHESIS SYSTEM

(71) Applicant: YAMAHA CORPORATION, SHIZUOKA (JP)

(72) Inventors: DAIKI KURAMITSU, SHIZUOKA (JP); SHOKO NARA, SHIZUOKA (JP); TSUYOSHI MIYAKI, SHIZUOKA (JP); HIROMASA SHIIHARA, SHIZUOKA (JP); KENICHI YAMAUCHI, SHIZUOKA (JP); SUSUMU YAMANAKA, SHIZUOKA (JP)

(21) Appl. No.: 16/622,387

(22) PCT Filed: Jun. 14, 2018
(86) PCT No.: PCT/JP2018/022815

§ 371 Date: Dec. 13, 2019

(30) Foreign Application Priority Data
Jun. 14, 2017 (JP) 2017-116830

(51) Int. Cl. G10L 13/04; G10L 25/63

(52) U.S. Cl. CPC G10L 13/043; G10L 25/63

(57) ABSTRACT

Disclosed are a singing voice synthesis method and a singing voice synthesis system. The singing voice synthesis method includes: detecting a trigger for singing voice synthesis; reading out parameters according to a user who has input the trigger from a table in which parameters used for singing voice synthesis are recorded in association with the user; and synthesizing a singing voice by using the read-out parameters. The singing voice synthesis system includes: a detecting unit that detects a trigger for singing voice synthesis; a reading unit that reads out parameters according to a user who has input the trigger from a table in which parameters used for singing voice synthesis are recorded in association with the user; and a synthesizing unit that synthesizes a singing voice by using the read-out parameters.

### BACKGROUND

The present disclosure relates to a technique for outputting a voice including a singing voice to a user.

There is a technique for automatically generating a musical piece including a melody and lyrics. Japanese Patent Laid-Open No. 2006-84749 (hereinafter referred to as Patent Document 1) discloses a technique for selecting a material based on additional data associated with material data and synthesizing a musical piece by using the selected material. Furthermore, Japanese Patent Laid-Open No. 2012-88402 (hereinafter referred to as Patent Document 2) discloses a technique for extracting an important phrase that reflects a message desired to be delivered by a music creator from lyrics information.

### SUMMARY

In recent years, a “voice assistant” that makes a response by a voice to an input voice of a user has been proposed. The present disclosure is a technique for automatically carrying out singing voice synthesis by using parameters according to the user and it is impossible to implement such singing voice synthesis with the techniques of Patent Documents 1 and 2.

The present disclosure provides a singing voice synthesis method including detecting a trigger for singing voice synthesis, reading out parameters according to a user who has input the trigger from a table in which parameters used for singing voice synthesis are recorded in association with the user, and synthesizing a singing voice by using the read-out parameters.

In the singing voice synthesis method, in the table, the parameters used for singing voice synthesis may be recorded in association with the user and emotions. Furthermore, the singing voice synthesis method may have estimating emotion of the user who has input the trigger and, in the reading out the parameters from the table, parameters according to the user who has input the trigger and the emotion of the user may be read out.

In the estimating the emotion of the user, a voice of the user may be analyzed and the emotion of the user may be estimated based on a result of the analysis.

The estimating the emotion of the user may include at least processing of estimating an emotion based on contents of the voice of the user or processing of estimating an emotion based on a pitch, a volume, or a change in speed regarding the voice of the user.

The singing voice synthesis method may further include acquiring lyrics used for the singing voice synthesis, acquiring a melody used for the singing voice synthesis, and correcting one of the lyrics and the melody based on another.

The singing voice synthesis method may further include selecting one database according to the trigger from a plurality of databases in which voice fragments acquired from a plurality of singers are recorded and, in the synthesizing the singing voice, the singing voice may be synthesized by using voice fragments recorded in the one database.

The singing voice synthesis method may further include selecting a plurality of databases according to the trigger from a plurality of databases in which voice fragments acquired from a plurality of singers are recorded and, in the synthesizing the singing voice, the singing voice may be synthesized by using voice fragments obtained by combining a plurality of voice fragments recorded in the plurality of databases.

In the table, lyrics used for the singing voice synthesis may be recorded in association with the user. Furthermore, in the synthesizing the singing voice, the singing voice may be synthesized by using the lyrics recorded in the table.

The singing voice synthesis method may further include acquiring lyrics from one source selected from a plurality of sources according to the trigger and, in the synthesizing the singing voice, the singing voice may be synthesized by using the lyrics acquired from the selected one source.

The singing voice synthesis method may further include generating an accompaniment corresponding to the synthesized singing voice and synchronizing and outputting the synthesized singing voice and the generated accompaniment.

Furthermore, the present disclosure provides a singing voice synthesis system including a detecting unit that detects a trigger for singing voice synthesis, a reading unit that reads out parameters according to a user who has input the trigger from a table in which parameters used for singing voice synthesis are recorded in association with the user, and a synthesizing unit that synthesizes a singing voice by using the read-out parameters.

According to the present disclosure, singing voice synthesis can be automatically carried out by using parameters according to the user.

### BRIEF DESCRIPTION OF THE DRAWINGS

FIG. 1 is a diagram depicting the outline of a voice response system according to one embodiment;

FIG. 2 is a diagram exemplifying the outline of functions of the voice response system;

FIG. 3 is a diagram exemplifying the hardware configuration of an input-output apparatus;

FIG. 4 is a diagram exemplifying the hardware configuration of a response engine and a singing voice synthesis engine;

FIG. 5 is a diagram exemplifying a functional configuration relating to a learning function;

FIG. 6 is a flowchart depicting the outline of operation relating to the learning function;

FIG. 7 is a sequence chart exemplifying the operation relating to the learning function;

FIG. 8 is a diagram exemplifying a classification table;

FIG. 9 is a diagram exemplifying a functional configuration relating to a singing voice synthesis function;

FIG. 10 is a flowchart depicting the outline of operation relating to the singing voice synthesis function;

FIG. 11 is a sequence chart exemplifying the operation relating to the singing voice synthesis function;

FIG. 12 is a diagram exemplifying a functional configuration relating to a response function;

FIG. 13 is a flowchart exemplifying operation relating to the response function;

FIG. 14 is a diagram depicting operation example 1 of the voice response system;

FIG. 15 is a diagram depicting operation example 2 of the voice response system;

FIG. 16 is a diagram depicting operation example 3 of the voice response system;

FIG. 17 is a diagram depicting operation example 4 of the voice response system;

FIG. 18 is a diagram depicting operation example 5 of the voice response system;

FIG. 19 is a diagram depicting operation example 6 of the voice response system;

FIG. 20 is a diagram depicting operation example 7 of the voice response system;

FIG. 21 is a diagram depicting operation example 8 of the voice response system; and

FIG. 22 is a diagram depicting operation example 9 of the voice response system.

### DETAILED DESCRIPTION OF THE PREFERRED EMBODIMENT

### 1. System Outline

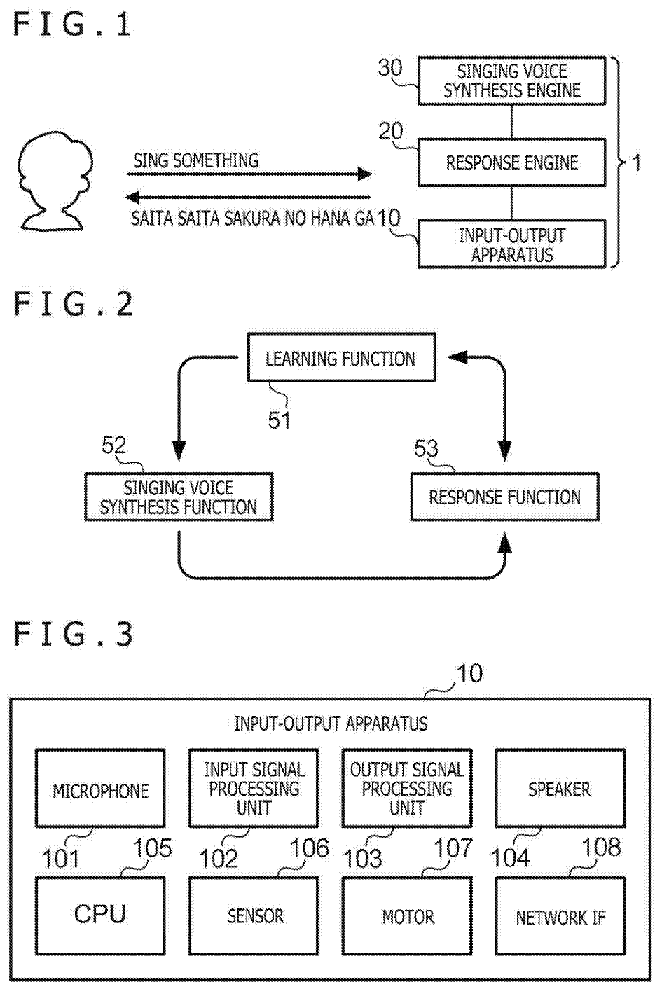

FIG. 1 is a diagram depicting the outline of a voice response system 1 according to one embodiment. The voice response system 1 is a system that automatically outputs a response by a voice in response to an input when a user carries out the input (or order) by a voice, and is what is generally called an artificial intelligence (AI) voice assistant. Hereinafter, the voice input from a user to the voice response system 1 will be referred to as “input voice” and the voice output from the voice response system 1 in response to the input voice will be referred to as “response voice.” The voice response includes singing. The voice response system 1 is one example of a singing voice synthesis system. For example, when a user says to the voice response system 1, “Sing something,” the voice response system 1 automatically synthesizes a singing voice and outputs the synthesized singing voice.

The voice response system 1 includes an input-output apparatus 10, a response engine 20, and a singing voice synthesis engine 30. The input-output apparatus 10 is an apparatus that provides a human machine interface and is an apparatus that accepts an input voice from a user and outputs a response voice to the input voice. The response engine 20 analyzes the input voice accepted by the input-output apparatus 10 and generates the response voice. At least part of this response voice includes a singing voice. The singing voice synthesis engine 30 synthesizes a singing voice used as the response voice.

FIG. 2 is a diagram exemplifying the outline of functions of the voice response system 1. The voice response system 1 has a learning function 51, a singing voice synthesis function 52, and a response function 53. The response function 53 is a function of analyzing an input voice of a user and providing a response voice based on the analysis result and is provided by the input-output apparatus 10 and the response engine 20. The learning function 51 is a function of learning preference of a user from an input voice of the user and is provided by the singing voice synthesis engine 30. The singing voice synthesis function 52 is a function of synthesizing a singing voice used as a response voice and is provided by the singing voice synthesis engine 30. The learning function 51 learns preference of the user by using the analysis result obtained by the response function 53. The singing voice synthesis function 52 synthesizes the singing voice based on the learning carried out by the learning function 51. The response function 53 makes a response using the singing voice synthesized by the singing voice synthesis function 52.

FIG. 3 is a diagram exemplifying the hardware configuration of the input-output apparatus 10. The input-output apparatus 10 has a microphone 101, an input signal processing unit 102, an output signal processing unit 103, a speaker 104, a central processing unit (CPU) 105, a sensor 106, a motor 107, and a network interface (IF) 108. The microphone 101 converts a voice of a user to an electrical signal (input sound signal). The input signal processing unit 102 executes processing such as analog/digital conversion for the input sound signal and outputs data indicating an input voice (hereinafter referred to as “input voice data”). The output signal processing unit 103 executes processing such as analog/digital conversion for data indicating a response voice (hereinafter referred to as “response voice data”) and outputs an output sound signal. The speaker 104 converts the output sound signal to a sound (outputs the sound based on the output sound signal). The CPU 105 controls other elements of the input-output apparatus 10 and reads out a program from a memory (not depicted) to execute it. The sensor 106 detects the position of the user (direction of the user viewed from the input-output apparatus 10) and is an infrared sensor or ultrasonic sensor, for example. The motor 107 changes the orientation of at least one of the microphone 101 and the speaker 104 to cause it to be oriented in the direction in which the user exists. The microphone 101 may be formed of a microphone array and the CPU 105 may detect the direction in which the user exists based on a sound collected by the microphone array. The network IF 108 is an interface for carrying out communication through a network (for example, the Internet) and includes an antenna and a chipset for carrying out communication in accordance with a predetermined wireless communication standard (for example, wireless fidelity (Wi-Fi) (registered trademark)), for example.

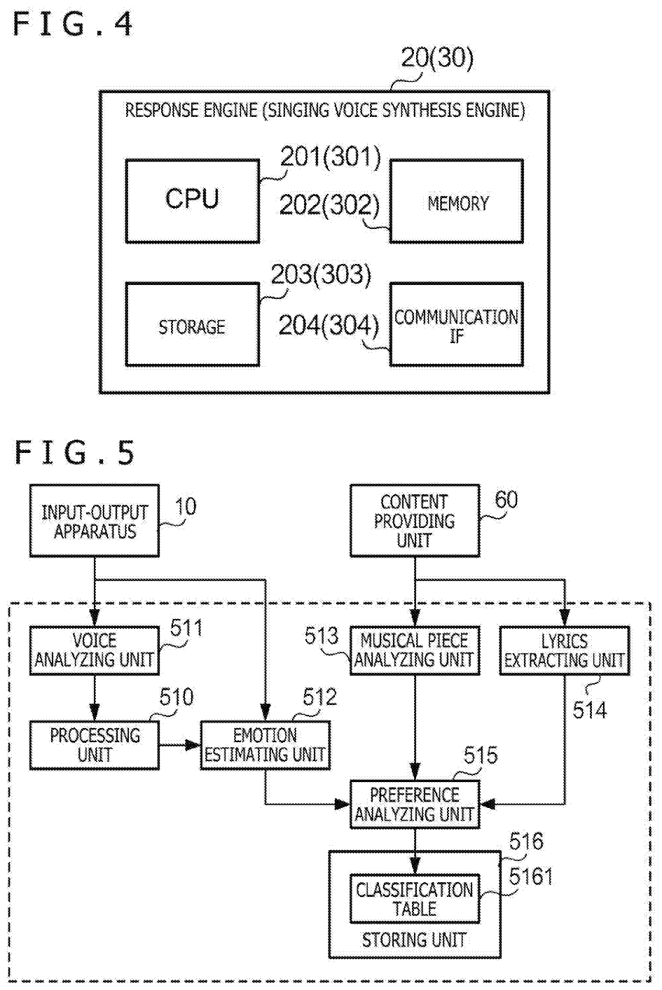

FIG. 4 is a diagram exemplifying the hardware configuration of the response engine 20 and the singing voice synthesis engine 30. The response engine 20 has a CPU 201, a memory 202, a storage 203, and a communication IF 204. The CPU 201 execute various kinds of arithmetic operation in accordance with a program and controls other elements of a computer apparatus. The memory 202 is a main storing apparatus that functions as a work area when the CPU 201 executes a program, and includes a random access memory (RAM), for example. The storage 203 is a non-volatile auxiliary storing apparatus that stores various kinds of programs and data and includes a hard disk drive (HDD) or a solid state drive (SSD), for example. The communication IF 204 includes a connector and a chipset for carrying out communication in accordance with a predetermined communication standard (for example, Ethernet). The storage 203 stores a program for causing the computer apparatus to function as the response engine 20 in the voice response system 1 (hereinafter referred to as “response program”). Through execution of the response program by the CPU 201, the computer apparatus functions as the response engine 20. The response engine 20 is what is generally called an AI, for example.

The singing voice synthesis engine 30 has a CPU 301, a memory 302, a storage 303, and a communication IF 304. Details of each element are similar to the response engine 20. The storage 303 stores a program for causing the computer apparatus to function as the singing voice synthesis engine 30 in the voice response system 1 (hereinafter referred to as “singing voice synthesis program”). Through execution of the singing voice synthesis program by the CPU 301, the computer apparatus functions as the singing voice synthesis engine 30.

The response engine 20 and the singing voice synthesis engine 30 are provided as cloud services on the Internet. The response engine 20 and the singing voice synthesis engine 30 may be services that do not depend on cloud computing.

### 2. Learning Function

### 2-1. Configuration

FIG. 5 is a diagram exemplifying a functional configuration relating to the learning function 51. As functional elements relating to the learning function 51, the voice response system 1 has a voice analyzing unit 511, an emotion estimating unit 512, a musical piece analyzing unit 513, a lyrics extracting unit 514, a preference analyzing unit 515, a storing unit 516, and a processing unit 510. Furthermore, the input-output apparatus 10 functions as an accepting unit that accepts an input voice of a user and an output unit that outputs a response voice.

The voice analyzing unit 511 analyzes an input voice. This analysis is processing of acquiring information used for generating a response voice from the input voice. Specifically, this analysis includes processing of turning the input voice to text (that is, converting the input voice to a character string), processing of determining a request of a user from the obtained text, processing of identifying a content providing unit 60 that provides content in response to the request of a user, processing of making an order to the identified content providing unit 60, processing of acquiring data from the content providing unit 60, and processing of generating a response by using the acquired data. In this example, the content providing unit 60 is an external system of the voice response system 1. The content providing unit 60 provides a service (for example, streaming service of musical pieces or network radio) of outputting data for reproducing content of a musical piece or the like as sounds (hereinafter referred to as “musical piece data”), and is an external server of the voice response system 1, for example.

The musical piece analyzing unit 513 analyzes the musical piece data output from the content providing unit 60. The analysis of the musical piece data refers to processing of extracting characteristics of a musical piece. The characteristics of a musical piece include at least one of tune, rhythm, chord progression, tempo, and arrangement. A publicly-known technique is used for the extraction of the characteristics.

The lyrics extracting unit 514 extracts lyrics from the musical piece data output from the content providing unit 60. In one example, the musical piece data includes metadata in addition to sound data. The sound data is data indicating the signal waveform of a musical piece and includes uncompressed data such as pulse code modulation (PCM) data or compressed data such as MPEG-1 Audio Layer 3 (MP3) data, for example. The metadata is data including information relating to the musical piece and includes attributes of the musical piece, such as music title, performer name, composer name, lyric writer name, album title, and genre, and information on lyrics and so forth, for example. The lyrics extracting unit 514 extracts lyrics from the metadata included in the musical piece data. If the musical piece data does not include the metadata, the lyrics extracting unit 514 executes voice recognition processing for sound data and extracts lyrics from text obtained by voice recognition.

The emotion estimating unit 512 estimates the emotion of a user. The emotion estimating unit 512 estimates the emotion of a user from an input voice. A publicly-known technique is used for the estimation of the emotion. The emotion estimating unit 512 may estimate the emotion of a user based on the relationship between the (average) pitch in voice output by the voice response system 1 and the pitch of a response by the user in response to it. The emotion estimating unit 512 may estimate the emotion of a user based on an input voice turned to text by the voice analyzing unit 511 or an analyzed request of a user.

The preference analyzing unit 515 generates information indicating the preference of a user (hereinafter referred to as “preference information”) by using at least one of the reproduction history of a musical piece ordered to be reproduced by the user, an analysis result, lyrics, and the emotion of the user when the reproduction of the musical piece is ordered. The preference analyzing unit 515 updates a classification table 5161 stored in the storing unit 516 by using the generated preference information. The classification table 5161 is a table (or database) in which the preference of the user is recorded, and is a table in which characteristics of the musical piece (for example, tone, tune, rhythm, chord progression, and tempo), attributes of the musical piece (performer name, composer name, lyric writer name, and genre), and lyrics are recorded regarding each user and each emotion, for example. The storing unit 516 is one example of a reading unit that reads out parameters according to a user who has input a trigger from a table in which parameters used for singing voice synthesis are recorded in association with the user. The parameters used for singing voice synthesis are data to which reference is carried out in singing voice synthesis and the classification table 5161 is a concept including tone, tune, rhythm, chord progression, tempo, performer name, composer name, lyric writer name, genre, and lyrics.

### 2-2. Operation

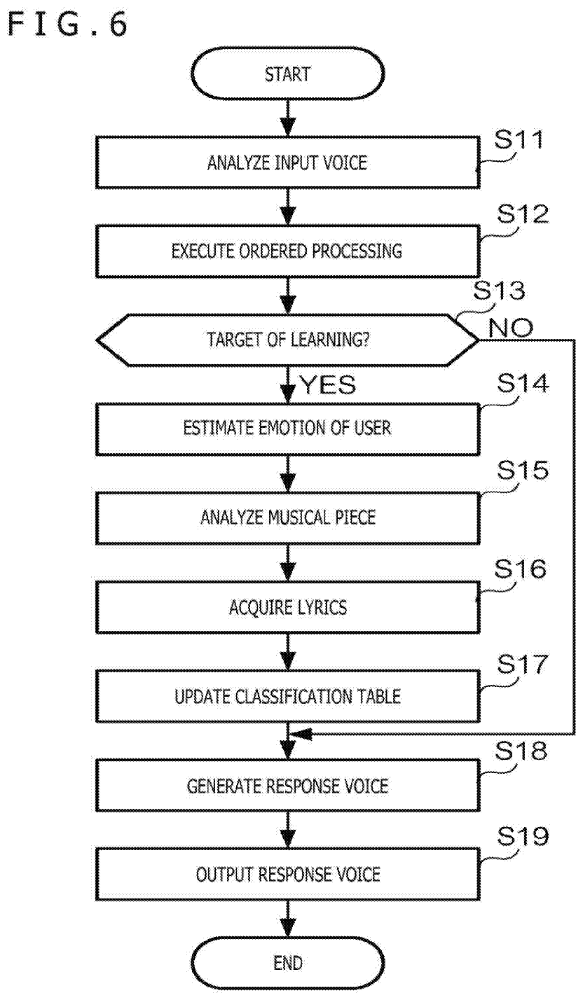

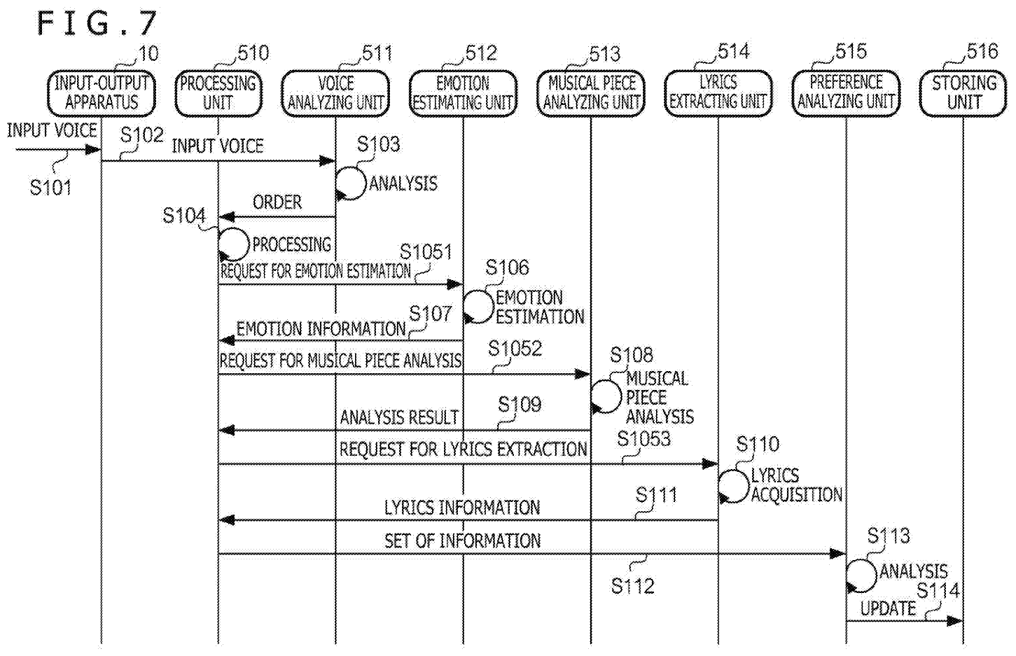

FIG. 6 is a flowchart depicting the outline of operation of the voice response system 1 relating to the learning function 51. In a step S11, the voice response system 1 analyzes an input voice. In a step S12, the voice response system 1 executes processing ordered by the input voice. In a step S13, the voice response system 1 determines whether the input voice includes a matter as a target of learning. If it is determined that the input voice includes a matter as a target of learning (S13: YES), the voice response system 1 shifts the processing to a step S14. If it is determined that the input voice does not include a matter as a target of learning (S13: NO), the voice response system 1 shifts the processing to a step S18. In the step S14, the voice response system 1 estimates the emotion of the user. In a step S15, the voice response system 1 analyzes a musical piece ordered to be reproduced. In a step S16, the voice response system 1 acquires lyrics of the musical piece ordered to be reproduced. In a step S17, the voice response system 1 updates the classification table by using the pieces of information obtained in the steps S14 to S16.

The processing of the step S18 and the subsequent step does not have a direct relation with the learning function 51, i.e. update of the classification table, but includes processing using the classification table. In the step S18, the voice response system 1 generates a response voice to the input voice. At this time, reference to the classification table is carried out according to need. In a step S19, the voice response system 1 outputs the response voice.

FIG. 7 is a sequence chart exemplifying the operation of the voice response system 1 relating to the learning function 51. A user carries out user registration in the voice response system 1 at the time of entry to the voice response system 1 or at the time of first activation, for example. The user registration includes setting of a user name (or login identification (ID)) and a password. At the start timing of the sequence of FIG. 7, the input-output apparatus 10 has been activated and login processing of the user has been completed. That is, in the voice response system 1, the user who is using the input-output apparatus 10 has been identified. Furthermore, the input-output apparatus 10 is in the state of waiting for voice input (utterance) by the user. The method for identifying the user by the voice response system 1 is not limited to the login processing. For example, the voice response system 1 may identify the user based on an input voice.

In a step S101, the input-output apparatus 10 accepts an input voice. The input-output apparatus 10 turns the input voice to data and generates voice data. The voice data includes sound data indicating the signal waveform of the input voice and a header. Information indicating attributes of the input voice is included in the header. The attributes of the input voice include an identifier for identifying the input-output apparatus 10, a user identifier (for example, user name or login ID) of the user who uttered the voice, and a timestamp indicating the clock time when the voice has been uttered, for example. In a step S102, the input-output apparatus 10 outputs voice data indicating the input voice to the voice analyzing unit 511.

In a step S103, the voice analyzing unit 511 analyzes the input voice by using the voice data. In this analysis, the voice analyzing unit 511 determines whether the input voice includes a matter as a target of learning. The matter as a target of learning is a matter to identify a musical piece and specifically is a reproduction order of a musical piece.

In a step S104, the processing unit 510 executes processing ordered by the input voice. The processing executed by the processing unit 510 is streaming reproduction of a musical piece, for example. In this case, the content providing unit 60 has a musical piece database in which plural pieces of musical piece data are recorded. The processing unit 510 reads out the musical piece data of the ordered musical piece from the musical piece database. The processing unit 510 transmits the read-out musical piece data to the input-output apparatus 10 as the transmission source of the input voice. In another example, the processing executed by the processing unit 510 is playing of a network radio. In this case, the content providing unit 60 carries out streaming broadcasting of radio voice. The processing unit 510 transmits streaming data received from the content providing unit 60 to the input-output apparatus 10 as the transmission source of the input voice.

If it is determined in the step S103 that the input voice includes a matter as a target of learning, the processing unit 510 further executes processing for updating the classification table (step S105). The processing for updating the classification table includes a request for emotion estimation to the emotion estimating unit 512 (step S1051), a request for musical piece analysis to the musical piece analyzing unit 513 (step S1052), and a request for lyrics extraction to the lyrics extracting unit 514 (step S1053).

When emotion estimation is requested, the emotion estimating unit 512 estimates the emotion of the user (step S106) and outputs information indicating the estimated emotion (hereinafter referred to as “emotion information”) to the processing unit 510, which is the request source (step S107). The emotion estimating unit 512 estimates the emotion of the user by using the input voice. The emotion estimating unit 512 estimates the emotion based on the input voice turned to text, for example. In one example, a keyword that represents an emotion is defined in advance and, if the input voice turned to text includes this keyword, the emotion estimating unit 512 determines that the user has the emotion (for example, determines that the emotion of the user is “angry” if a keyword of “damn” is included). In another example, the emotion estimating unit 512 estimates the emotion based on the pitch, volume, and speed of the input voice or time change in them. In one example, if the average pitch of the input voice is lower than a threshold, the emotion estimating unit 512 determines that the emotion of the user is “sad.” In another example, the emotion estimating unit 512 may estimate the emotion of the user based on the relationship between the (average) pitch in voice output by the voice response system 1 and the pitch of a response by the user in response to it. Specifically, if the pitch of voice uttered by the user as a response is low although the pitch of voice output by the voice response system 1 is high, the emotion estimating unit 512 determines that the emotion of the user is “sad.” In further another example, the emotion estimating unit 512 may estimate the emotion of the user based on the relationship between the pitch of the end of words in voice and the pitch of a response by the user in response to it. Alternatively, the emotion estimating unit 512 may estimate the emotion of the user through considering these plural factors multiply.

In another example, the emotion estimating unit 512 may estimate the emotion of the user by using an input other than the voice. As an input other than the voice, for example, video of the face of the user photographed by a camera or the body temperature of the user detected by a temperature sensor or a combination of them is used. Specifically, the emotion estimating unit 512 determines which of “happy,” “angry,” and “sad” the emotion of the user is, from the facial expression of the user. Furthermore, the emotion estimating unit 512 may determine the emotion of the user based on change in the facial expression in a moving image of the face of the user.

Alternatively, the emotion estimating unit 512 may determine that the emotion is “angry” when the body temperature of the user is high, and determine that the emotion is “sad” when the body temperature of the user is low.

When musical piece analysis is requested, the musical piece analyzing unit 513 analyzes the musical piece to be reproduced based on the order by the user (step S108) and outputs information indicating the analysis result (hereinafter referred to as “musical piece information”) to the processing unit 510, which is the request source (step S109).

When lyrics extraction is requested, the lyrics extracting unit 514 acquires lyrics of the musical piece to be reproduced based on the order by the user (step S110) and outputs information indicating the acquired lyrics (hereinafter referred to as “lyrics information”) to the processing unit 510, which is the request source (step S111).

In a step S112, the processing unit 510 outputs, to the preference analyzing unit 515, a set of the emotion information, the musical piece information, and the lyrics information acquired from the emotion estimating unit 512, the musical piece analyzing unit 513, and the lyrics extracting unit 514, respectively.

In a step S113, the preference analyzing unit 515 analyzes plural sets of information and obtains information indicating the preference of the user. For this analysis, the preference analyzing unit 515 records plural sets of these kinds of information over a certain period in the past (for example, period from the start of running of the system to the present timing). In one example, the preference analyzing unit 515 executes statistical processing of the musical piece information and calculates a statistical representative value (for example, mean, mode, or median). By this statistical processing, for example, the mean of the tempo and the modes of tone, tune, rhythm, chord progression, composer name, lyric writer name, and performer name are obtained. Furthermore, the preference analyzing unit 515 decomposes lyrics indicated by the lyrics information into a word level by using a technique of morphological analysis or the like and thereafter identifies the part of speech of each word. Then, the preference analyzing unit 515 creates a histogram about words of a specific part of speech (for example, nouns) and identifies a word whose appearance frequency falls within a predetermined range (for example, top 5%). Moreover, the preference analyzing unit 515 extracts word groups that include the identified word and correspond to a predetermined range in syntax (for example, sentence, clause, or phrase) from the lyrics information. For example, if the appearance frequency of a word of “like” is high, word groups including this word, such as “I like you” and “Because I like you very much,” are extracted from the lyrics information. These mean, modes, and word groups are one example of the information indicating the preference of the user (parameters).

Alternatively, the preference analyzing unit 515 may analyze plural sets of information in accordance with a predetermined algorithm different from mere statistical processing and obtain the information indicating the preference of the user.

Alternatively, the preference analyzing unit 515 may accept feedback from the user and adjust the weight of these parameters according to the feedback. In a step S114, the preference analyzing unit 515 updates the classification table 5161 by using the information obtained by the step S113.

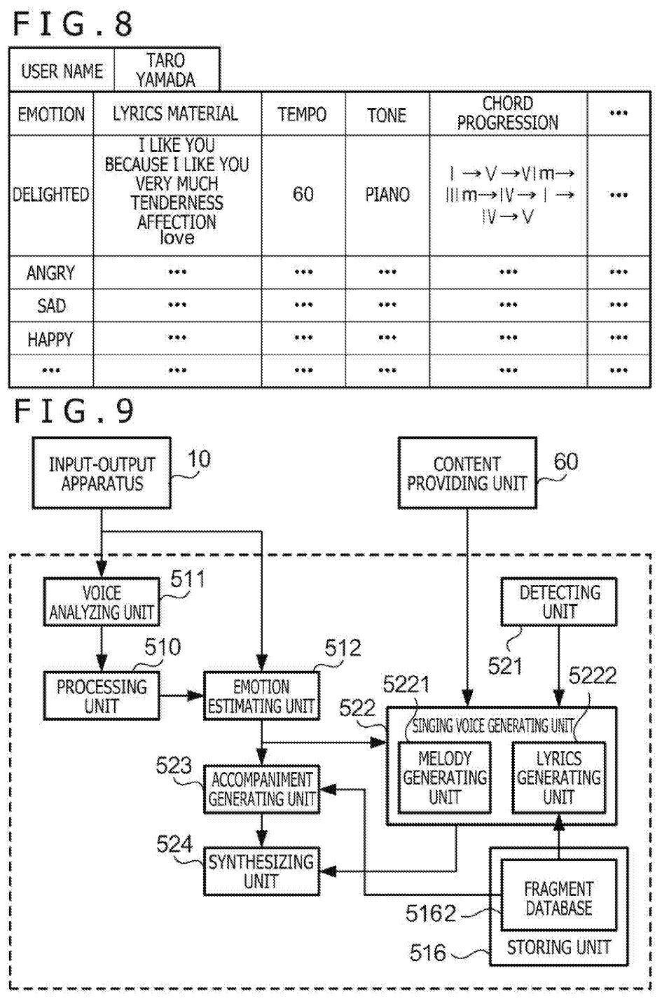

FIG. 8 is a diagram exemplifying the classification table 5161. In this diagram, the classification table 5161 of a user whose user name is “Taro Yamada” is indicated. In the classification table 5161, characteristics, attributes, and lyrics of musical pieces are recorded in association with emotions of the user. Through reference to the classification table 5161, for example, it is indicated that, when having an emotion of “delighted,” the user “Taro Yamada” prefers musical pieces that include words of “tenderness,” “affection,” and “love” in lyrics and have a tempo of approximately 60 and a chord progression of “I→V→VIm→IIIm→IV→I→IV→V” and mainly have a tone of piano. According to the present embodiment, the information indicating the preference of the user can be automatically obtained. The preference information recorded in the classification table 5161 is accumulated as the learning progresses, that is, as the cumulative use time of the voice response system 1 increases, and becomes what reflects the preference of the user more. According to this example, information that reflects the preference of the user can be automatically obtained.

The preference analyzing unit 515 may set initial values of the classification table 5161 at a predetermined timing such as the timing of user registration or the timing of first login. In this case, the voice response system 1 may cause the user to select a character that represents the user on the system (for example, what is generally called an avatar) and set the classification table 5161 having initial values according to the selected character as the classification table corresponding to the user.

The data recorded in the classification table 5161 explained in the present embodiment is one example. For example, emotions of the user do not have to be recorded in the classification table 5161 and it suffices that at least lyrics are recorded therein. Alternatively, lyrics do not have to be recorded in the classification table 5161 and it suffices that at least emotions of the user and results of musical piece analysis are recorded therein.

### 3. Singing Voice Synthesis Function

### 3-1. Configuration

FIG. 9 is a diagram exemplifying a functional configuration relating to the singing voice synthesis function 52. As functional elements relating to the singing voice synthesis function 52, the voice response system 1 has the voice analyzing unit 511, the emotion estimating unit 512, the storing unit 516, a detecting unit 521, a singing voice generating unit 522, an accompaniment generating unit 523, and a synthesizing unit 524. The singing voice generating unit 522 has a melody generating unit 5221 and a lyrics generating unit 5222. In the following, description is omitted about elements common to the learning function 51.

Regarding the singing voice synthesis function 52, the storing unit 516 stores a fragment database 5162. The fragment database is a database in which voice fragment data used in singing voice synthesis is recorded. The voice fragment data is what is obtained by turning one or plural phonemes to data. The phoneme is what is equivalent to the minimum unit of distinction of the linguistic meaning (for example, vowel and consonant) and is the minimum unit in phonology of a certain language, set in consideration of actual articulation of the language and the whole phonological system. The voice fragment is what is obtained through cutting out a section equivalent to a desired phoneme or phonemic chain in an input voice uttered by a specific uttering person. The voice fragment data in the present embodiment is data indicating the frequency spectrum of a voice fragment. In the following description, the term of “voice fragment” includes a single phoneme (for example, monophone) and phonemic chain (for example, diphone and triphone).

The storing unit 516 may store plural fragment databases 5162. The plural fragment databases 5162 may include databases in which phonemes uttered by singers (or speakers) different from each other are recorded, for example. Alternatively, the plural fragment databases 5162 may include databases in which phonemes uttered by a single singer (or speaker) with ways of singing or tones of voice different from each other are recorded.

The singing voice generating unit 522 generates a singing voice, that is, carries out singing voice synthesis. The singing voice refers to a voice when given lyrics are uttered in accordance with a given melody. The melody generating unit 5221 generates a melody used for the singing voice synthesis. The lyrics generating unit 5222 generates lyrics used for the singing voice synthesis. The melody generating unit 5221 and the lyrics generating unit 5222 may generate the melody and the lyrics by using information recorded in the classification table 5161. The singing voice generating unit 522 generates a singing voice by using the melody generated by the melody generating unit 5221 and the lyrics generated by the lyrics generating unit 5222. The accompaniment generating unit 523 generates an accompaniment for the singing voice. The synthesizing unit 524 synthesizes a singing voice by using the singing voice generated by the singing voice generating unit 522, the accompaniment generated by the accompaniment generating unit 523, and voice fragments recorded in the fragment database 5162.

### 3-2. Operation

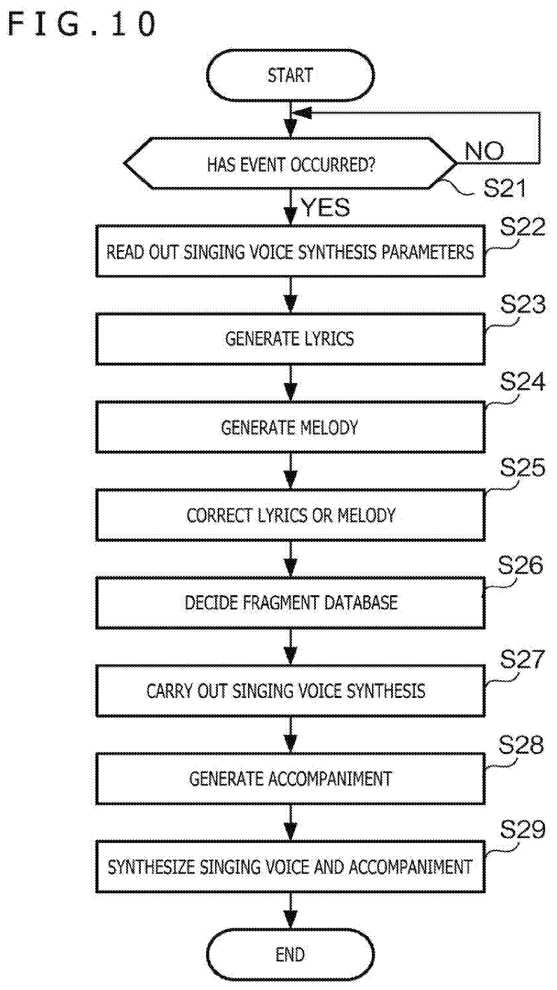

FIG. 10 is a flowchart depicting the outline of operation (singing voice synthesis method) of the voice response system 1 relating to the singing voice synthesis function 52. In a step S21, the voice response system 1 determines (detects) whether an event that triggers singing voice synthesis has occurred. For example, the event that triggers singing voice synthesis includes at least one of an event that voice input has been carried out from a user, an event registered in a calendar (for example, alarm or user's birthday), an event that an order of singing voice synthesis has been input from the user by a method other than voice (for example, operation to a smartphone (not depicted) wirelessly connected to the input-output apparatus 10), and an event that randomly occurs. If it is determined that an event that triggers singing voice synthesis has occurred (S21: YES), the voice response system 1 shifts the processing to a step S22. If it is determined that an event that triggers singing voice synthesis has not occurred (S21: NO), the voice response system 1 waits until an event that triggers singing voice synthesis occurs.

In a step S22, the voice response system 1 reads out singing voice synthesis parameters. In a step S23, the voice response system 1 generates lyrics. In a step S24, the voice response system 1 generates a melody. In a step S25, the voice response system 1 corrects one of the generated lyrics and melody in conformity to the other. In a step S26, the voice response system 1 selects the fragment database to be used. In a step S27, the voice response system 1 carries out singing voice synthesis by using the lyrics, the melody, and the fragment database obtained in the steps S23, S24, and S26. In a step S28, the voice response system 1 generates an accompaniment. In a step S29, the voice response system 1 synthesizes the singing voice and the accompaniment. The processing of the steps S23 to S29 is part of the processing of the step S18 in the flow of FIG. 6. The operation of the voice response system 1 relating to the singing voice synthesis function 52 will be described below in more detail.

FIG. 11 is a sequence chart exemplifying the operation of the voice response system 1 relating to the singing voice synthesis function 52. When detecting an event that triggers singing voice synthesis, the detecting unit 521 makes a request for singing voice synthesis to the singing voice generating unit 522 (step S201). The request for singing voice synthesis includes an identifier of the user. When the singing voice synthesis is requested, the singing voice generating unit 522 inquires the preference of the user of the storing unit 516 (step S202). This inquiry includes the user identifier. When receiving the inquiry, the storing unit 516 reads out the preference information corresponding to the user identifier included in the inquiry from the classification table 5161 and outputs the read-out preference information to the singing voice generating unit 522 (step S203). Moreover, the singing voice generating unit 522 inquires the emotion of the user of the emotion estimating unit 512 (step S204). This inquiry includes the user identifier. When receiving the inquiry, the emotion estimating unit 512 outputs the emotion information of the user to the singing voice generating unit 522 (step S205).

In a step S206, the singing voice generating unit 522 selects the source of lyrics. The source of lyrics is decided according to the input voice. The source of lyrics is either the processing unit 510 or the classification table 5161 in a rough classification. A request for singing voice synthesis output from the processing unit 510 to the singing voice generating unit 522 includes lyrics (or lyrics material) in some cases and does not include lyrics in other cases. The lyrics material refers to a character string that is difficult to form lyrics by itself and forms lyrics by being combined with another lyrics material. The case in which the request for singing voice synthesis includes lyrics refers to the case in which a melody is given to a response itself by an AI (“Tomorrow's weather is fine” or the like) and a response voice is output, for example. Because the request for singing voice synthesis is generated by the processing unit 510, it can also be said that the source of lyrics is the processing unit 510. Moreover, the processing unit 510 acquires content from the content providing unit 60 in some cases. Thus, it can also be said that the source of lyrics is the content providing unit 60. The content providing unit 60 is a server that provides news or a server that provides weather information, for example. Alternatively, the content providing unit 60 is a server having a database in which lyrics of existing musical pieces are recorded. Although only one content providing unit 60 is depicted in the diagrams, plural content providing units 60 may exist. If lyrics are included in the request for singing voice synthesis, the singing voice generating unit 522 selects the request for singing voice synthesis as the source of lyrics. If lyrics are not included in the request for singing voice synthesis (for example, if the order by the input voice is what does not particularly specify the contents of lyrics, such as “Sing something”), the singing voice generating unit 522 selects the classification table 5161 as the source of lyrics.

In a step S207, the singing voice generating unit 522 requests the selected source to provide a lyrics material. Here, an example in which the classification table 5161, i.e. the storing unit 516, is selected as the source is indicated. In this case, this request includes the user identifier and the emotion information of the user. When receiving the request for lyrics material provision, the storing unit 516 extracts the lyrics material corresponding to the user identifier and the emotion information included in the request from the classification table 5161 (step S208). The storing unit 516 outputs the extracted lyrics material to the singing voice generating unit 522 (step S209).

When acquiring the lyrics material, the singing voice generating unit 522 requests the lyrics generating unit 5222 to generate lyrics (step S210). This request includes the lyrics material acquired from the source. When generation of lyrics is requested, the lyrics generating unit 5222 generates lyrics by using the lyrics material (step S211). The lyrics generating unit 5222 generates lyrics by combining plural lyrics materials, for example. Alternatively, each source may store lyrics of the whole of one musical piece. In this case, the lyrics generating unit 5222 may select lyrics of one musical piece used for singing voice synthesis from the lyrics stored by the source. The lyrics generating unit 5222 outputs the generated lyrics to the singing voice generating unit 522 (step S212).

In a step S213, the singing voice generating unit 522 requests the melody generating unit 5221 to generate a melody. This request includes the preference information of the user and information to identify the number of syllabic sounds of lyrics. The information to identify the number of syllabic sounds of lyrics is the number of characters, the number of moras, or the number of syllables of the generated lyrics. When generation of a melody is requested, the melody generating unit 5221 generates a melody according to the preference information included in the request (step S214). Specifically, a melody is generated as follows, for example. The melody generating unit 5221 can access a database of the material of the melody (for example, a note sequence having a length of about two bars or four bars or information sequence obtained through segmentation of a note sequence into musical factors such as the rhythm and change in the pitch) (hereinafter referred to as “melody database,” not depicted). The melody database is stored in the storing unit 516, for example. In the melody database, attributes of the melody are recorded. The attributes of the melody include musical piece information such as compatible tune or lyrics and the composer name, for example. The melody generating unit 5221 selects one or plural materials in conformity to the preference information included in the request from materials recorded in the melody database and combines the selected materials to obtain a melody with the desired length. The singing voice generating unit 522 outputs information to identify the generated melody (for example, sequence data of musical instrument digital interface (MIDI) or the like) to the singing voice generating unit 522 (step S215).

In a step S216, the singing voice generating unit 522 requests the melody generating unit 5221 to correct the melody or requests the lyrics generating unit 5222 to generate lyrics. One of objects of this correction is to cause the number of syllabic sounds (for example, the number of moras) of the lyrics and the number of sounds of the melody to correspond with each other. For example, if the number of moras of the lyrics is smaller than the number of sounds of the melody (in the case of insufficient syllable), the singing voice generating unit 522 requests the lyrics generating unit 5222 to increase the number of characters of the lyrics. Alternatively, if the number of moras of the lyrics is larger than the number of sounds of the melody (in the case of extra syllable), the singing voice generating unit 522 requests the melody generating unit 5221 to increase the number of sounds of the melody. In this diagram, an example in which the lyrics are corrected is explained. In a step S217, the lyrics generating unit 5222 corrects the lyrics in response to the request for correction. In the case of correcting the melody, the melody generating unit 5221 corrects the melody by splitting notes to increase the number of notes, for example. The lyrics generating unit 5222 or the melody generating unit 5221 may carry out adjustment to cause the delimiter parts of clauses of the lyrics to correspond with the delimiter parts of phrases of the melody. The lyrics generating unit 5222 outputs the corrected lyrics to the singing voice generating unit 522 (step S218).

When receiving the lyrics, the singing voice generating unit 522 selects the fragment database 5162 to be used for the singing voice synthesis (step S219). The fragment database 5162 is selected according to attributes of the user relating to the event that has triggered the singing voice synthesis, for example. Alternatively, the fragment database 5162 may be selected according to the contents of the event that has triggered the singing voice synthesis. Further alternatively, the fragment database 5162 may be selected according to the preference information of the user recorded in the classification table 5161. The singing voice generating unit 522 synthesizes voice fragments extracted from the selected fragment database 5162 in accordance with the lyrics and the melody obtained by the processing executed thus far to obtain data of the synthesized singing voice (step S220). In the classification table 5161, information indicating the preference of the user relating to performance styles of singing, such as change in the tone of voice, “tame” (slight delaying of singing start from accompaniment start), “shakuri” (smooth transition from low pitch), and vibrato in singing may be recorded. Furthermore, the singing voice generating unit 522 may synthesize a singing voice that reflects performance styles according to the preference of the user with reference to these pieces of information. The singing voice generating unit 522 outputs the generated data of the synthesized singing voice to the synthesizing unit 524 (step S221).

Moreover, the singing voice generating unit 522 requests the accompaniment generating unit 523 to generate an accompaniment (step S222). This request includes information indicating the melody in the singing voice synthesis. The accompaniment generating unit 523 generates an accompaniment according to the melody included in the request (step S223). A well-known technique is used as a technique for automatically giving the accompaniment to the melody. If data indicating the chord progression of the melody (hereinafter “chord progression data”) is recorded in the melody database, the accompaniment generating unit 523 may generate the accompaniment by using this chord progression data. Alternatively, if chord progression data for the accompaniment for the melody is recorded in the melody database, the accompaniment generating unit 523 may generate the accompaniment by using this chord progression data. Further alternatively, the accompaniment generating unit 523 may store plural pieces of audio data of the accompaniment in advance and read out the audio data that matches the chord progression of the melody from them. Furthermore, the accompaniment generating unit 523 may refer to the classification table 5161 for deciding the tune of the accompaniment, for example, and generate the accompaniment according to the preference of the user. The accompaniment generating unit 523 outputs data of the generated accompaniment to the synthesizing unit 524 (step S224).

When receiving the data of the synthesized singing voice and the accompaniment, the synthesizing unit 524 synthesizes the synthesized singing voice and the accompaniment (step S225). In the synthesis, the singing voice and the accompaniment are synthesized to synchronize with each other by adjusting the start position of the performance and the tempo. In this manner, data of the synthesized singing voice with the accompaniment is obtained. The synthesizing unit 524 outputs the data of the synthesized singing voice.

Here, the example in which lyrics are generated first and thereafter a melody is generated in conformity to the lyrics is described. However, the voice response system 1 may generate a melody first and thereafter generate lyrics in conformity to the melody. Furthermore, here the example in which a singing voice and an accompaniment are output after being synthesized is described. However, without generation of an accompaniment, only a singing voice may be output (that is, singing may be a cappella). Moreover, here the example in which an accompaniment is generated in conformity to lyrics after the lyrics are synthesized is described. However, first an accompaniment may be generated and lyrics may be synthesized in conformity to the accompaniment.

### 4. Response Function

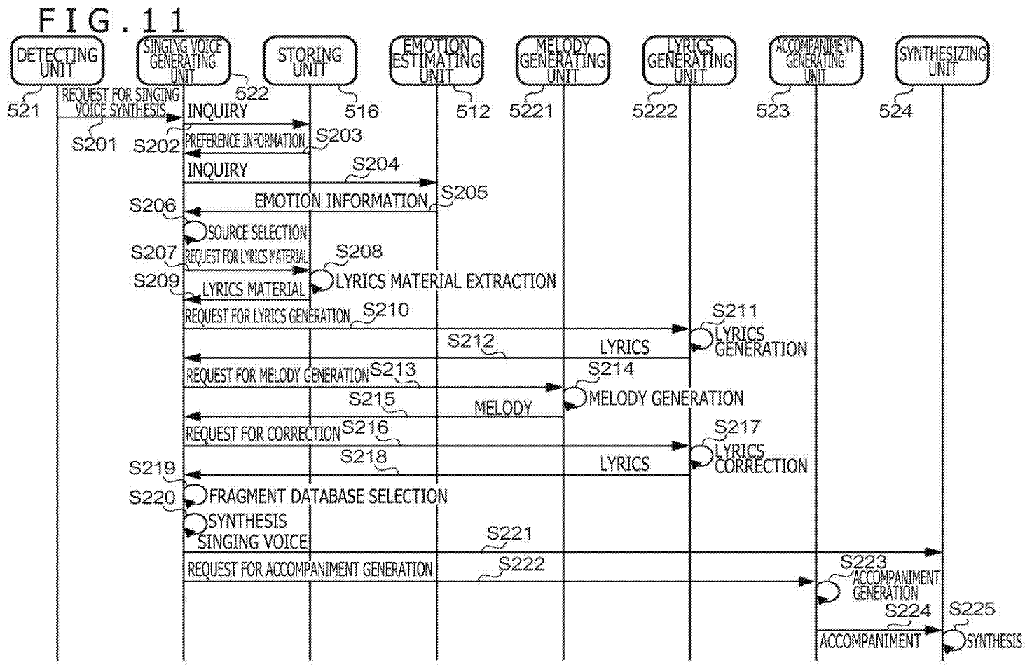

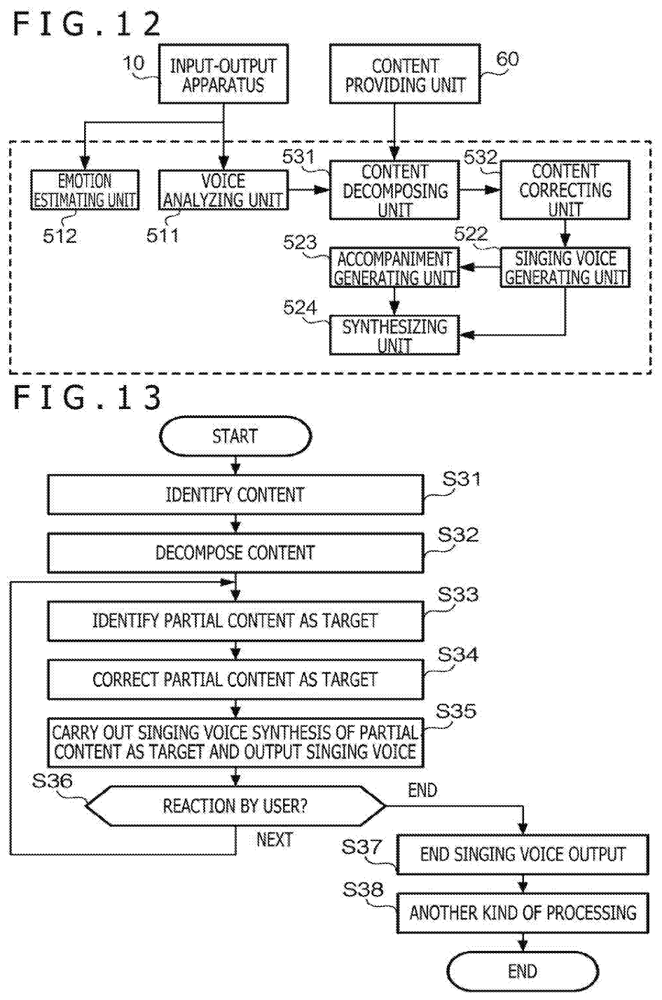

FIG. 12 is a diagram exemplifying the functional configuration of the voice response system 1 relating to the response function 53. As functional elements relating to the response function 53, the voice response system 1 has the voice analyzing unit 511, the emotion estimating unit 512, a content decomposing unit 531, and a content correcting unit 532. In the following, description is omitted about elements common to the learning function 51 and the singing voice synthesis function 52. The content decomposing unit 531 decomposes one piece of content into plural pieces of partial content. The content refers to the contents of information output as a response voice and specifically refers to a musical piece, news, recipe, or teaching material (sports instruction, musical instrument instruction, learning workbook, quiz), for example.

FIG. 13 is a flowchart exemplifying operation of the voice response system 1 relating to the response function 53. In a step S31, the voice analyzing unit 511 identifies content to be reproduced. The content to be reproduced is identified according to an input voice of a user, for example. Specifically, the voice analyzing unit 511 analyzes the input voice and identifies content ordered to be reproduced by the input voice. In one example, when an input voice of “Tell me a recipe for a hamburger patty” is given, the voice analyzing unit 511 orders the processing unit 510 to provide a “recipe for a hamburger patty.” The processing unit 510 accesses the content providing unit 60 and acquires text data that explains the “recipe for a hamburger patty.” The data thus acquired is identified as the content to be reproduced. The processing unit 510 informs the identified content to the content decomposing unit 531.

In a step S32, the content decomposing unit 531 decomposes the content into plural pieces of partial content. In one example, the “recipe for a hamburger patty” is composed of plural steps (cutting ingredients, mixing ingredients, forming a shape, baking, and so forth) and the content decomposing unit 531 decomposes the text of the “recipe for a hamburger patty” into four pieces of partial content, “step of cutting ingredients,” “step of mixing ingredients,” “step of forming a shape,” and “step of baking.” The decomposition positions of the content are automatically determined by an AI, for example. Alternatively, markers that represent delimiting may be buried in the content in advance and the content may be decomposed at the positions of the markers.

In a step S33, the content decomposing unit 531 identifies one piece of partial content as the target in the plural pieces of partial content (one example of the identifying unit). The partial content as the target is partial content to be reproduced and is decided according to the positional relationship of the partial content in the original content. In the example of the “recipe for a hamburger patty,” first the content decomposing unit 531 identifies the “step of cutting ingredients” as the partial content as the target. When the processing of the step S33 is executed next, the content decomposing unit 531 identifies the “step of mixing ingredients” as the partial content as the target. The content decomposing unit 531 notifies the identified partial content to the content correcting unit 532.

In a step S34, the content correcting unit 532 corrects the partial content as the target. The specific correction method is defined according to the content. For example, the content correcting unit 532 does not carry out correction for content such as news, weather information, and recipe. For example, for content of a teaching material or quiz, the content correcting unit 532 replaces a part desired to be hidden as a question by another sound (for example, humming, “la la la,” beep sound, or the like). At this time, the content correcting unit 532 carries out the replacement by using a character string with the same number of moras or syllables as the character string before the replacement. The content correcting unit 532 outputs the corrected partial content to the singing voice generating unit 522.

In a step S35, the singing voice generating unit 522 carries out singing voice synthesis of the corrected partial content. The singing voice generated by the singing voice generating unit 522 is finally output from the input-output apparatus 10 as a response voice. When outputting the response voice, the voice response system 1 becomes the state of waiting for a response by the user (step S36). In the step S36, the voice response system 1 may output a singing voice or voice that prompts a response by the user (for example, “Have you finished?” or the like). The voice analyzing unit 511 decides the next processing according to the response by the user. If a response that prompts reproduction of the next partial content is input (S36: next), the voice analyzing unit 511 shifts the processing to the step S33. The response that prompts reproduction of the next partial content is a voice of “To the next step,” “I have finished,” “I have ended,” or the like, for example. If a response other than the response that prompts reproduction of the next partial content is input (S36: end), the voice analyzing unit 511 orders the processing unit 510 to stop the output of the voice.

In a step S37, the processing unit 510 stops the output of the synthesized voice of partial content at least temporarily. In a step S38, the processing unit 510 executes processing according to an input voice by the user. In the processing in the step S38, stop of reproduction of the present content, keyword search ordered from the user, start of reproduction of another piece of content are included, for example. For example, if a response of “I want to stop the song,” “This is the end,” “Finish,” or the like is input, the processing unit 510 stops reproduction of the present content. For example, if a question-type response such as “How is cutting into rectangles done?” or “What is Aglio Olio?” is input, the processing unit 510 acquires information for answering the question of the user from the content providing unit 60. The processing unit 510 outputs a voice of an answer to the question of the user. This answer does not have to be a singing voice and may be a speaking voice. If a response to order reproduction of another piece of content, such as “Play music by ∘∘,” is input, the processing unit 510 acquires the ordered content from the content providing unit 60 and reproduces it.

The example is described in which content is decomposed into plural pieces of partial content and the next processing is decided according to a reaction by the user regarding each piece of partial content. However, without decomposition into pieces of partial content, content may be output as it is as a speaking voice or be output as a singing voice for which the content is used as lyrics. According to an input voice of the user or according to content to be output, the voice response system 1 may determine whether the content is to be decomposed into pieces of partial content or is to be output as it is without decomposition.

### 5. Operation Examples

Several specific operation examples will be described below. The respective operation examples are each based on at least one or more of the above-described learning function, singing voice synthesis function, and response function although this is not clearly indicated in each operation example particularly. The following operation examples all explain examples in which English is used. However, the language used is not limited to English and may be any language.

### 5-1. Operation Example 1

FIG. 14 is a diagram depicting operation example 1 of the voice response system 1. A user requests reproduction of a musical piece by an input voice of “Play “SAKURA SAKURA (CHERRY BLOSSOMS CHERRY BLOSSOMS)” (music title) by ICHITARO SATO (performer name).” The voice response system 1 searches the musical piece database in accordance with this input voice and reproduces the requested musical piece. At this time, the voice response system 1 updates the classification table by using the emotion of the user when this input voice has been input and the analysis result of this musical piece. The voice response system 1 updates the classification table every time reproduction of a musical piece is requested. The classification table becomes what reflects the preference of the user more as the number of times the user requests the voice response system 1 to reproduce a musical piece increases (that is, as the cumulative use time of the voice response system 1 increases).

### 5-2. Operation Example 2

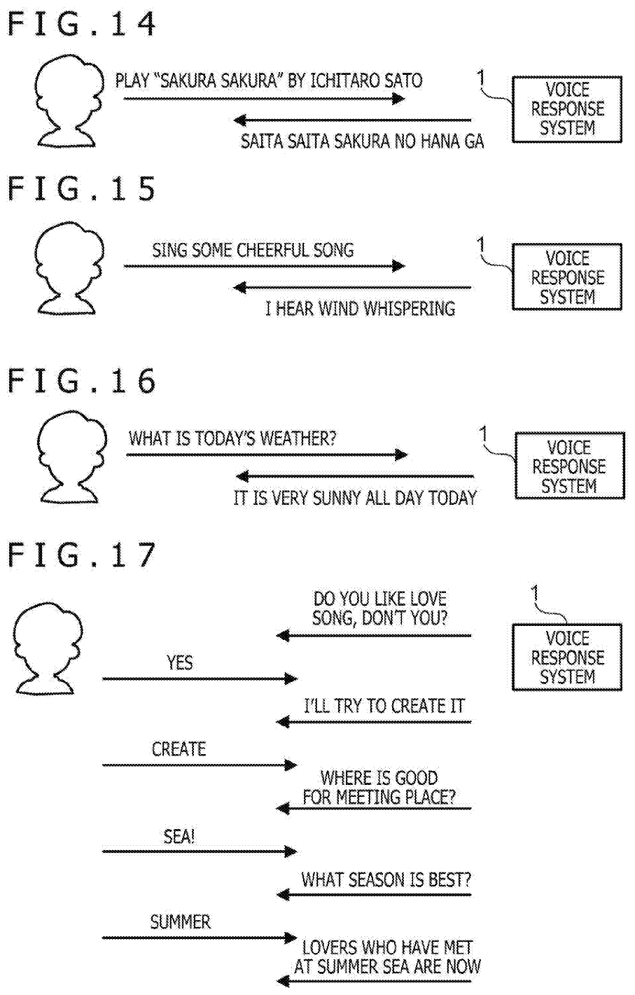

FIG. 15 is a diagram depicting operation example 2 of the voice response system 1. A user requests singing voice synthesis by an input voice of “Sing some cheerful song.” The voice response system 1 carries out singing voice synthesis in accordance with this input voice. In the singing voice synthesis, the voice response system 1 refers to the classification table. The voice response system 1 generates lyrics and a melody by using information recorded in the classification table. Therefore, a musical piece that reflects the preference of the user can be automatically created.

### 5-3. Operation Example 3

FIG. 16 is a diagram depicting operation example 3 of the voice response system 1. A user requests provision of weather information by an input voice of “What is today's weather?” In this case, the processing unit 510 accesses a server that provides weather information in the content providing unit 60 and acquires text indicating today's weather (for example, “It is very sunny all day today”) as an answer to this request. The processing unit 510 outputs a request for singing voice synthesis including the acquired text to the singing voice generating unit 522. The singing voice generating unit 522 carries out singing voice synthesis by using the text included in this request as lyrics. The voice response system 1 outputs a singing voice obtained by giving a melody and an accompaniment to “It is very sunny all day today” as the answer to the input voice.

### 5-4. Operation Example 4

FIG. 17 is a diagram depicting operation example 4 of the voice response system 1. Before responses depicted in the diagram are started, the user has used the voice response system 1 for two weeks and frequently reproduced love songs. Thus, information indicating that the user likes love songs is recorded in the classification table. The voice response system 1 asks questions such as “Where is good for the meeting place?” and “What season is the best?” to the user in order to obtain information that serves as a hint for lyrics generation. The voice response system 1 generates lyrics by using answers by the user to these questions. Because the use period is still as short as two weeks, the classification table of the voice response system 1 has not yet sufficiently reflected the preference of the user and associating with emotions is also not sufficient. For this reason, although actually the user prefers ballad-style music, rock-style music different from it is generated in some cases.

### 5-5. Operation Example 5

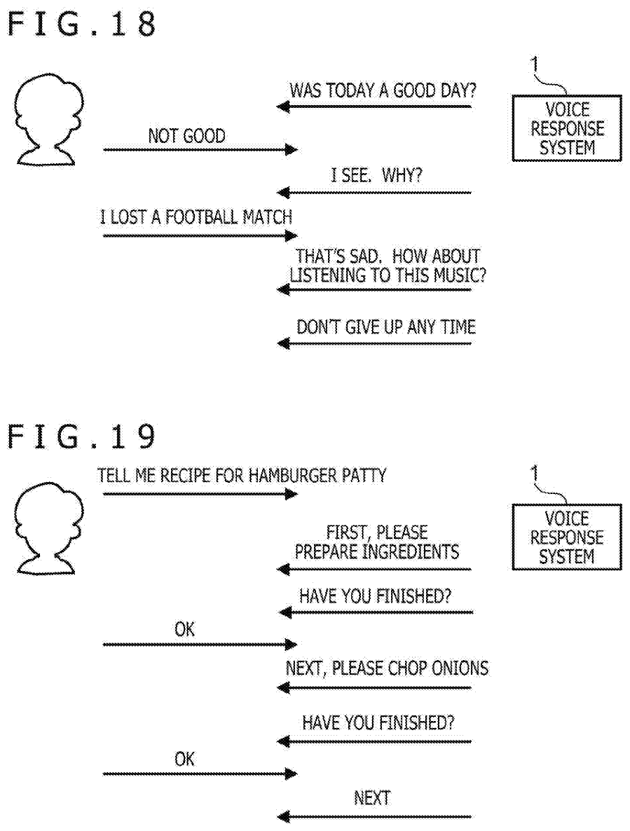

FIG. 18 is a diagram depicting operation example 5 of the voice response system 1. This example depicts an example in which use of the voice response system 1 has been further continued from operation example 3 and the cumulative use period has become one and a half months. Compared with operation example 3, the classification table has become what reflects the preference of the user and a singing voice that matches the preference of the user is synthesized. The user can have an experience that the reaction by the voice response system 1 that is incomplete at first gradually changes to match the preference of the user.

### 5-6. Operation Example 6

FIG. 19 is a diagram depicting operation example 6 of the voice response system 1. A user requests provision of content of a “recipe” for a “hamburger patty” by an input voice of “Will you tell me a recipe for a hamburger patty?” Based on a point that the content of the “recipe” is content that should proceed to the next step after a certain step ends, the voice response system 1 decomposes the content into pieces of partial content and decides to carry out reproduction in a form in which the next processing is decided according to a reaction by the user. The “recipe” for a “hamburger patty” is decomposed on each step basis and the voice response system 1 outputs a voice that prompts a response by the user, such as “Have you finished?” or “Have you ended?,” every time a singing voice of each step is output. When the user utters an input voice to order singing of the next step, such as “I have finished” or “Next?,” the voice response system 1 outputs a singing voice of the next step in response to it. When the user utters an input voice of asking a question of “How is chopping of an onion done?,” the voice response system 1 outputs a singing voice of “chopping of an onion” in response to it. When ending the singing of “chopping of an onion,” the voice response system 1 starts singing from the sequel of the “recipe” for a “hamburger patty.”

Between a singing voice of first partial content and a singing voice of second partial content subsequent to it, the voice response system 1 may output a singing voice of another piece of content. For example, the voice response system 1 outputs a singing voice synthesized to have a time length according to a matter indicated by a character string included in the first partial content between the singing voice of the first partial content and the singing voice of the second partial content. Specifically, when the first partial content indicates that a waiting time of 20 minutes occurs like “Here please simmer ingredients for 20 minutes,” the voice response system 1 synthesizes and outputs a singing voice of 20 minutes played while ingredients are simmered.

Furthermore, the voice response system 1 may output a singing voice synthesized by using a second character string according to a matter indicated by a first character string included in the first partial content after outputting of the singing voice of the first partial content at a timing corresponding to a time length according to the matter indicated by the first character string. Specifically, when the first partial content indicates that a waiting time of 20 minutes occurs like “Here please simmer ingredients for 20 minutes,” the voice response system 1 may output a singing voice of “Simmering has ended” (one example of the second character string) after 20 minutes from the outputting of the first partial content.

Alternatively, in the example in which the first partial content is “Here please simmer ingredients for 20 minutes,” singing of content such as “10 minutes until the end of simmering” in a rap manner may be carried out when half of the waiting time (10 minutes) has elapsed.

### 5-7. Operation Example 7

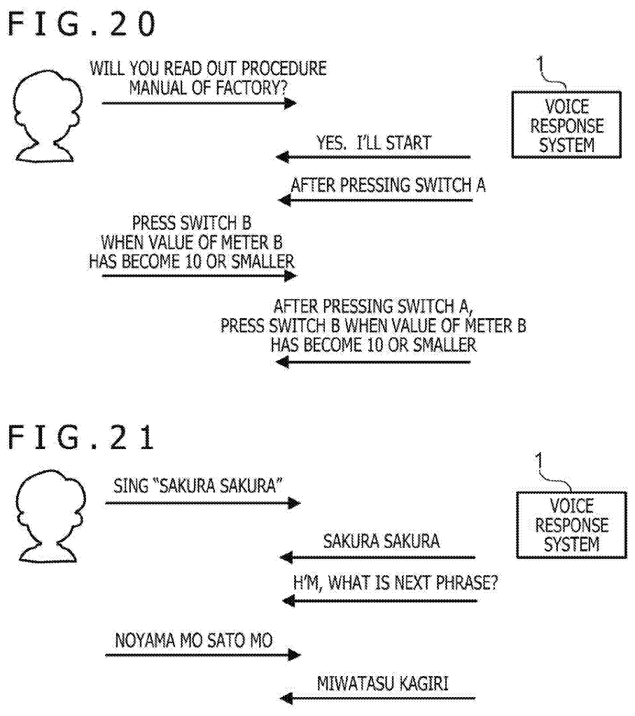

FIG. 20 is a diagram depicting operation example 7 of the voice response system 1. A user requests provision of content of a “procedure manual” by an input voice of “Will you read out the procedure manual of steps in the factory?” Based on a point that the content of the “procedure manual” is content for checking the memory of the user, the voice response system 1 decomposes the content into pieces of partial content and decides to carry out reproduction in a form in which the next processing is decided according to a reaction by the user.

For example, the voice response system 1 delimits the procedure manual at random positions to decompose it into plural pieces of partial content. After outputting a singing voice of one piece of partial content, the voice response system 1 waits for a reaction by the user. For example, because of content of procedure of “After pressing switch A, press switch B when the value of meter B has become 10 or smaller,” the voice response system 1 sings a part of “After pressing switch A” and waits for a reaction by the user. When the user utters some voice, the voice response system 1 outputs a singing voice of the next partial content. Alternatively, at this time, the speed of singing of the next partial content may be changed according to whether or not the user has correctly said the next partial content. Specifically, if the user has correctly said the next partial content, the voice response system 1 raises the speed of singing of the next partial content. Alternatively, if the user has failed in correctly saying the next partial content, the voice response system 1 lowers the speed of singing of the next partial content.

### 5-8. Operation Example 8

FIG. 21 is a diagram depicting operation example 8 of the voice response system 1. Operation example 8 is an operation example of a countermeasure against dementia of the elderly. That the user is an elderly person has been set by user registration or the like in advance. The voice response system 1 begins to sing an existing song in response to an order by the user, for example. The voice response system 1 suspends the singing at a random position or a predetermined position (for example, before hook). At this time, the voice response system 1 utters a message such as “H'm, I don't know” or “I forget” and behaves as if the voice response system 1 forgot lyrics. The voice response system 1 waits for a response by the user in this state. When the user utters some voice, the voice response system 1 regards the words (or part thereof) uttered by the user as correct lyrics and outputs a singing voice from the sequel to the words. When the user utters some words, the voice response system 1 may output a response such as “Thank you.” When a predetermined time has elapsed in the state of waiting for a response by the user, the voice response system 1 may output a speaking voice of “I have recalled” or the like and resume the singing from the sequel to the suspended part.

### 5-9. Operation Example 9

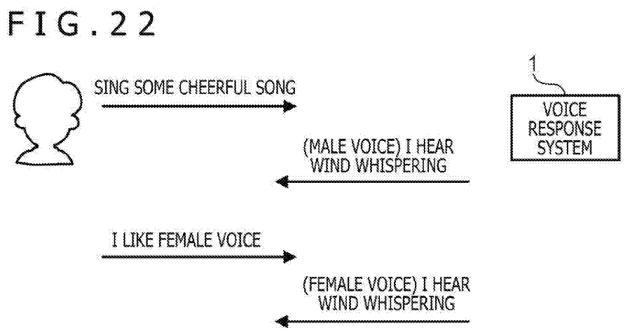

FIG. 22 is a diagram depicting operation example 9 of the voice response system 1. A user requests singing voice synthesis by an input voice of “Sing some cheerful song.” The voice response system 1 carries out singing voice synthesis in accordance with this input voice. The fragment database used in the singing voice synthesis is selected according to a character selected at the time of user registration, for example (for example, when a male character is selected, the fragment database based on male singers is used). The user utters an input voice to order change of the fragment database, such as “Change the voice to a female voice,” in the middle of the song. The voice response system 1 switches the fragment database used for the singing voice synthesis in response to the input voice by the user. The switching of the fragment database may be carried out when the voice response system 1 is outputting a singing voice or may be carried out when the voice response system 1 is in the state of waiting for a response by the user as in operation examples 7 and 8.

The voice response system 1 may have plural fragment databases in which phonemes uttered by a single singer (or speaker) with ways of singing or tones of voice different from each other are recorded. Regarding a certain phoneme, the voice response system 1 may use plural fragments extracted from the plural fragment databases in such a manner as to combine, i.e. add, them at a certain ratio (use ratio). The voice response system 1 may decide this use ratio according to a reaction by the user. Specifically, when two fragment databases are recorded for a normal voice and a sweet voice regarding a certain singer, the use ratio of the fragment database of the sweet voice is enhanced when a user utters an input voice of “With a sweeter voice,” and the use ratio of the fragment database of the sweet voice is further enhanced when the user utters an input voice of “With a further sweeter voice.”

### 6. Modification Examples

The present disclosure is not limited to the above-described embodiment and various modified implementations are possible. Several modification examples will be described below. Two or more examples in the following modification examples may be used in combination.

The singing voice in the present specification refers to a voice including singing in at least part thereof and may include a part of only an accompaniment that does not include singing or a part of only a speaking voice. For example, in an example in which content is decomposed into plural pieces of partial content, at least one piece of partial content does not have to include singing. Furthermore, singing may include a rap or recitation of a poem.

In the embodiment, the examples in which the learning function 51, the singing voice synthesis function 52, and the response function 53 are mutually related are described. However, these functions may be each provided alone. For example, a classification table obtained by the learning function 51 may be used in order to know the preference of a user in a musical piece delivery system that delivers musical pieces, for example. Alternatively, the singing voice synthesis function 52 may carry out singing voice synthesis by using a classification table manually input by a user. Furthermore, at least part of the functional elements of the voice response system 1 may be omitted. For example, the voice response system 1 does not need to have the emotion estimating unit 512.

Regarding the allocation of functions to the input-output apparatus 10, the response engine 20, and the singing voice synthesis engine 30, the voice analyzing unit 511 and the emotion estimating unit 512 may be mounted on the input-output apparatus, for example. Furthermore, regarding relative arrangement of the input-output apparatus 10, the response engine 20, and the singing voice synthesis engine 30, for example, the singing voice synthesis engine 30 may be disposed between the input-output apparatus 10 and the response engine 20 and singing voice synthesis may be carried out about the response determined to need the singing voice synthesis in responses output from the response engine 20. Moreover, content used in the voice response system 1 may be stored in a local apparatus such as the input-output apparatus 10 or an apparatus that can communicate with the input-output apparatus 10.

The hardware configuration of the input-output apparatus 10, the response engine 20, and the singing voice synthesis engine 30 may be a smartphone or tablet terminal, for example. Input to the voice response system 1 by the user is not limited to input through a voice and may be what is input through a touch screen, keyboard, or pointing device. Furthermore, the input-output apparatus 10 may have a motion sensor. The voice response system 1 may control operation by using this motion sensor depending on whether or not a user is present nearby. For example, if it is determined that a user is not present near the input-output apparatus 10, the voice response system 1 may carry out such operation as not to output a voice (not to return a dialogue). However, depending on the contents of a voice output by the voice response system 1, the voice response system 1 may output the voice irrespective of whether or not a user is present near the input-output apparatus 10. For example, the voice response system 1 may output a voice to guide the remaining waiting time like that described in the latter half of operation example 6 irrespective of whether or not a user is present near the input-output apparatus 10. Regarding detection of whether or not a user is present near the input-output apparatus 10, a sensor other than the motion sensor, such as a camera or temperature sensor, may be used and plural sensors may be used in combination.

The flowcharts and the sequence charts exemplified in the embodiment are one example. In the flowcharts and the sequence charts exemplified in the embodiment, the order of the processing may be changed and part of the processing may be omitted and new processing may be added.

A program executed in the input-output apparatus 10, the response engine 20, and the singing voice synthesis engine 30 may be provided in the state of being stored in a recording medium such as a compact disc-read-only memory (CD-ROM) or semiconductor memory, or may be provided by downloading through a network such as the Internet.

The present application is based on Japanese Patent Application (Japanese Patent Application No. 2017-116830) filed on Jun. 14, 2017 and is incorporated herein by reference.

According to the present disclosure, singing voice synthesis can be automatically carried out by using parameters according to the user. Thus, the present disclosure is useful.

It should be understood by those skilled in the art that various modifications, combinations, sub-combinations and alterations may occur depending on design requirements and other factors insofar as they are within the scope of the appended claims or the equivalent thereof.

What is claimed is:

1. A singing voice synthesis method comprising:
detecting a trigger for singing voice synthesis;
reading out parameters according to a user who has input the trigger from a table in which parameters used for singing voice synthesis are recorded in association with the user; and
synthesizing a singing voice by using the read-out parameters.

2. The singing voice synthesis method according to claim 1, wherein,
in the table, the parameters used for singing voice synthesis are recorded in association with the user and emotions,
the singing voice synthesis method has estimating an emotion of the user who has input the trigger, and,
in the reading out the parameters from the table, parameters according to the user who has input the trigger and the emotion of the user are read out.

3. The singing voice synthesis method according to claim 2, wherein,
in the estimating the emotion of the user, a voice of the user is analyzed and the emotion of the user is estimated based on a result of the analysis.

4. The singing voice synthesis method according to claim 3, wherein
the estimating the emotion of the user includes at least processing of estimating an emotion based on contents of the voice of the user or processing of estimating an emotion based on a pitch, a volume, or a change in speed regarding the voice of the user.

5. The singing voice synthesis method according to claim 1, further comprising:
acquiring lyrics used for the singing voice synthesis;
acquiring a melody used for the singing voice synthesis; and
correcting one of the lyrics and the melody based on another.

6. The singing voice synthesis method according to claim 1, further comprising:
selecting one database according to the trigger from a plurality of databases in which voice fragments acquired from a plurality of singers are recorded, wherein,
in the synthesizing the singing voice, the singing voice is synthesized by using voice fragments recorded in the one database.

7. The singing voice synthesis method according to claim 1, further comprising:
selecting a plurality of databases according to the trigger from a plurality of databases in which voice fragments acquired from a plurality of singers are recorded, wherein, in the synthesizing the singing voice, the singing voice is synthesized by using voice fragments obtained by combining a plurality of voice fragments recorded in the plurality of databases.

8. The singing voice synthesis method according to claim 1, wherein,
in the table, lyrics used for the singing voice synthesis are recorded in association with the user, and,
in the synthesizing the singing voice, the singing voice is synthesized by using the lyrics recorded in the table.

9. The singing voice synthesis method according to claim 1, further comprising:
acquiring lyrics from one source selected from a plurality of sources according to the trigger, wherein,
in the synthesizing the singing voice, the singing voice is synthesized by using the lyrics acquired from the selected one source.

10. The singing voice synthesis method according to claim 1, further comprising:
generating an accompaniment corresponding to the synthesized singing voice; and
synchronizing and outputting the synthesized singing voice and the generated accompaniment.

11. A singing voice synthesis system comprising:
a detecting unit that detects a trigger for singing voice synthesis;
a reading unit that reads out parameters according to a user who has input the trigger from a table in which parameters used for singing voice synthesis are recorded in association with the user; and
a synthesizing unit that synthesizes a singing voice by using the read-out parameters.

12. The singing voice synthesis system according to claim 11, wherein,
in the table, the parameters used for singing voice synthesis are recorded in association with the user and emotions,
the singing voice synthesis system has an estimating unit that estimates emotion of the user who has input the trigger, and
the reading unit reads out parameters according to the user who has input the trigger and the emotion of the user.

13. The singing voice synthesis system according to claim 12, wherein
the estimating unit analyzes a voice of the user and estimates the emotion of the user based on a result of the analysis.

14. The singing voice synthesis system according to claim 13, wherein
the estimating unit executes at least processing of estimating an emotion based on contents of the voice of the user or processing of estimating an emotion based on a pitch, a volume, or a change in speed regarding the voice of the user.

15. The singing voice synthesis system according to claim 11, further comprising:
a first acquiring unit that acquires lyrics used for the singing voice synthesis;
a second acquiring unit that acquires a melody used for the singing voice synthesis; and
a correcting unit that corrects one of the lyrics and the melody based on another.

16. The singing voice synthesis system according to claim 11, further comprising:
a selecting unit that selects one database according to the trigger from a plurality of databases in which voice fragments acquired from a plurality of singers are recorded, wherein
the synthesizing unit synthesizes the singing voice by using voice fragments recorded in the one database.

17. The singing voice synthesis system according to claim 11, further comprising:
a selecting unit that selects a plurality of databases according to the trigger from a plurality of databases in which voice fragments acquired from a plurality of singers are recorded, wherein
the synthesizing unit synthesizes the singing voice by using voice fragments obtained by combining a plurality of voice fragments recorded in the plurality of databases.

18. The singing voice synthesis system according to claim 11, wherein,
in the table, lyrics used for the singing voice synthesis are recorded in association with the user, and
the synthesizing unit synthesizes the singing voice by using the lyrics recorded in the table.

19. The singing voice synthesis system according to claim 15, wherein
the first acquiring unit acquires lyrics from one source selected from a plurality of sources according to the trigger, wherein
the synthesizing unit synthesizes the singing voice by using the lyrics acquired from the selected one source.

20. The singing voice synthesis system according to claim 11, further comprising:
a generating unit that generates an accompaniment corresponding to the synthesized singing voice;
a synchronizing unit that synchronizes the synthesized singing voice and the generated accompaniment; and
an outputting unit that outputs the accompaniment.
